(19) United States
(12) Patent Application Publication
(10) Pub. No.: US 2015/0234830 A1
(43) Pub. Date: Aug. 20, 2015

(54) METHOD AND SYSTEM FOR CREATING AND MANAGING A VERIFIED ONLINE PROFILE

(71) Applicant: CHECK YOURSELF LLC, Cincinnati, OH (US)

(72) Inventor: Michael Bergman, Cincinnati, OH (US)

(21) Appl. No.: 14/429,334

(22) PCT Filed: Sep. 19, 2013
(86) PCT No.: PCT/US13/60651

§ 371 Date: Mar. 18, 2015

Related U.S. Application Data
(60) Provisional application No. 61/702,980, filed on Sep. 19, 2012.

(51) Int. Cl. G06F 17/30

(52) U.S. Cl. CPC G06F 17/3053; G06F 17/30867

(57) ABSTRACT

A method and system for providing verified online profiles. The method and system comprises receiving identity information from a user. The identity information is obtained from a public record check from a remote database. It is determined if the public record is for the user, based on a score determined by comparing the name and birth date information from the user and the name and birth date information from the public record check. The scores are combined to obtain a matching score to determine if the public record check is for the user if the match score is predetermined above a threshold.

### RELATED APPLICATIONS

This application is related to U.S. Provisional application No. 61/702,980 filed on Sep. 19, 2012 and which is incorporated by reference.

### FIELD

This disclosure relates generally to a method and system for creating and managing a verified, online profile for an individual or an entity.

### BACKGROUND

Everyday millions of people interact with complete strangers. The interaction may take place via dating sites, online marketplaces, professional networking sites, and rental properties. Consumers do not have an easy way to know if each other is trustworthy, safe and legitimate. Thus, there exists a need for methods and systems that address the aforementioned problems.

### SUMMARY

Various embodiments are generally directed to inmate searching to overcome the aforementioned problems.

Embodiments of the invention provide an online identity and background management platform for individuals and providers of online services and goods.

A method comprising receiving identity information from a user. The identity information is obtained from a public record check from a remote database. It is determined if the public record is for the user. The name and birth name material from the user and the name and birth date information from the public record check are compared to obtain a score from each. The scores are combined to obtain a matching score. It is determined if the public record check is for the user if the match score is predetermined above a threshold.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

Embodiments will now be described in connection with the associated drawings, in which:

FIG. 1 depicts a block diagram of an exemplary system 100 in accordance with one or more embodiments.

FIG. 2 depicts a screen shot in accordance with one or more embodiments in accordance with one or more embodiments.

FIG. 3 depicts a screen shot in accordance with one or more embodiments.

FIG. 4 depicts an exemplary architecture for implementing a computing device in accordance with one or more embodiments.

FIG. 5 depicts a block flow diagram of an exemplary method in accordance with one or more embodiments.

### DETAILED DESCRIPTION OF THE DRAWINGS

Exemplary embodiments are discussed in detail below. While specific exemplary embodiments are discussed, it should be understood that this is done for illustration purposes only. In describing and illustrating the exemplary embodiments, specific terminology is employed for the sake of clarity. However, the embodiments are not intended to be limited to the specific terminology so selected. A person skilled in the relevant art will recognize that other components and configurations may be used without parting from the spirit and scope of the embodiments. It is to be understood that each specific element includes all technical equivalents that operate in a similar manner to accomplish a similar purpose. The examples and embodiments described herein are non-limiting examples.

An online identity and background management platform for individuals and providers of online services and goods is described. The platform may also be used in the mobile space. The platform may be used in a variety of different areas. For example, in the context of dating, a potential date can be assured that they can trust interacting with and letting a potential suitor into their lives. In ecommerce, transaction partners can be reassured to meet in person to complete a transaction that was initiated online. In a professional context, associate and colleagues can confirm that an individual is trustworthy and willing to share their background information. These are just a few examples and other use cases fall within the scope of the invention.

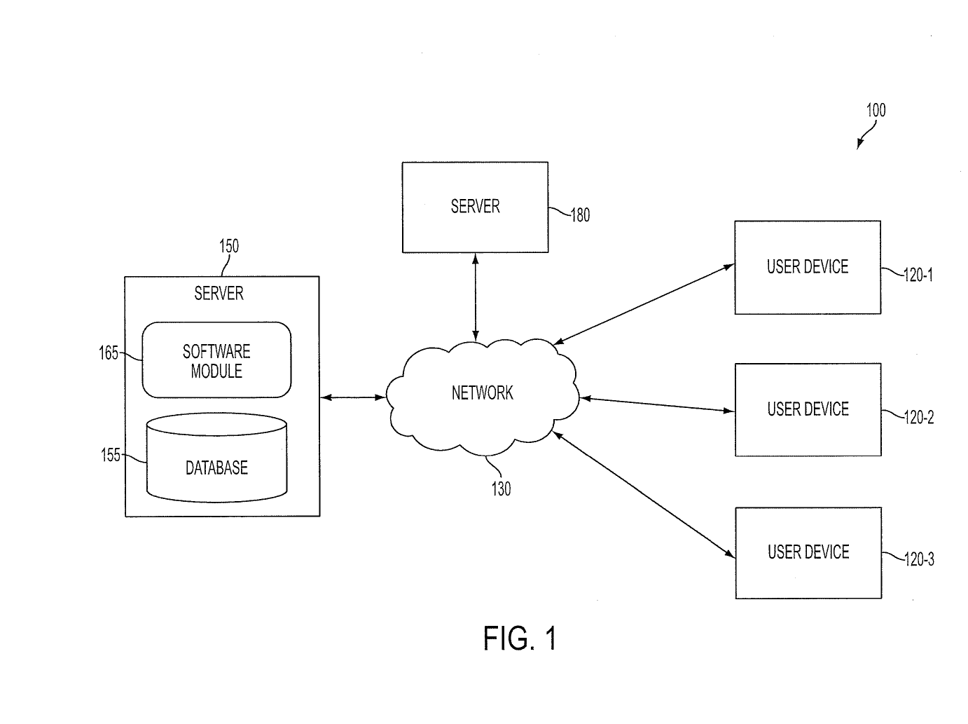

FIG. 1 depicts a block diagram of an exemplary system 100 in accordance with one or more embodiments. System 100 may include one or more user devices, e.g. user device 120-1, user device 120-2, and user device 120-3, network 130, server 150, database 155, software module 165, and server 180.

The one or more user devices, e.g. user device 120-1, user device 120-2, and user device 120-3, may any type of computing device, including a mobile telephone, a laptop, tablet, or desktop computer having, a netbook, a video game device, a pager, a smart phone, an ultra-mobile personal computer (UMPC), or a personal data assistant (PDA). The one or more user devices may run one or more applications, such as Internet browsers, voice calls, video games, videoconferencing, and email, among others. The one or more user devices may be any combination of computing devices. These devices may be coupled to network 130.

Network 130 may provide network access, data transport and other services to the devices coupled to it. In general, network 130 may include and implement any commonly defined network architectures including those defined by standards bodies, such as the Global System for Mobile communication (GSM) Association, the Internet Engineering Task Force (IETF), and the Worldwide Interoperability for Microwave Access (WiMAX) forum. For example, network 130 may implement one or more of a GSM architecture, a General Packet Radio Service (GPRS) architecture, a Universal Mobile Telecommunications System (UMTS) architecture, and an evolution of UMTS referred to as Long Term Evolution (LTE). Network 130 may, again as an alternative or in conjunction with one or more of the above, implement a WiMAX architecture defined by the WiMAX forum. Network 130 may also comprise, for instance, a local area network (LAN), a wide area network (WAN), the Internet, a virtual LAN (VLAN), an enterprise LAN, a layer 3 virtual private network (VPN), an enterprise IP network, or any combination thereof.

Server 150 or server 180 may also be any type of computing device coupled to network 130, including but not limited to a personal computer, a server computer, a series of server computers, a mini computer, and a mainframe computer, or combinations thereof. Server 150 or server 180 may be a web server (or a series of servers) running a network operating system, examples of which may include but are not limited to Microsoft Windows Server, Novell NetWare, or Linux. Server 150 or server 180 may be used for and/or provide cloud and/or network computing. Although not shown in FIG. 1, server 150 and or server 180 may have connections to external systems like email, SMS messaging, text messaging, ad content providers, etc. Any of the features of server 150 may be also implemented in server 180 and vice versa.

Database 155 may be any type of database, including a database managed by a database management system (DBMS). A DBMS is typically implemented as an engine that controls organization, storage, management, and retrieval of data in a database. DBMSs frequently provide the ability to query, backup and replicate, enforce rules, provide security, do computation, perform change and access logging, and automate optimization. Examples of DBMSs include Oracle database, IBM DB2, Adaptive Server Enterprise, FileMaker, Microsoft Access, Microsoft SQL Server, MySQL, PostgreSQL, and a NoSQL implementation. A DBMS typically includes a modeling language, data structure, database query language, and transaction mechanism. The modeling language is used to define the schema of each database in the DBMS, according to the database model, which may include a hierarchical model, network model, relational model, object model, or some other applicable known or convenient organization. Data structures can include fields, records, files, objects, and any other applicable known or convenient structures for storing data. A DBMS may also include metadata about the data that is stored.

Software module 165 may be a module that is configured to send, process, and receive information at server 150. Software module 165 may provide another mechanism for sending and receiving data at server 150 besides handling requests through web server functionalities. Software module 165 may send and receive information using any technique for sending and receiving information between processes or devices including but not limited to using a scripting language, a remote procedure call, an email, a tweet, an application programming interface, Simple Object Access Protocol (SOAP) methods, Common Object Request Broker Architecture (CORBA), HTTP (Hypertext Transfer Protocol), REST (Representational State Transfer), any interface for software components to communicate with each other, using any other known technique for sending information from a one device to another, or any combination thereof.

Although software module 165 may be described in relation to server 150, software module 165 may reside on any other device. Further, the functionality of software module 165 may be duplicated on, distributed across, and/or performed by one or more other devices, either in whole or in part.

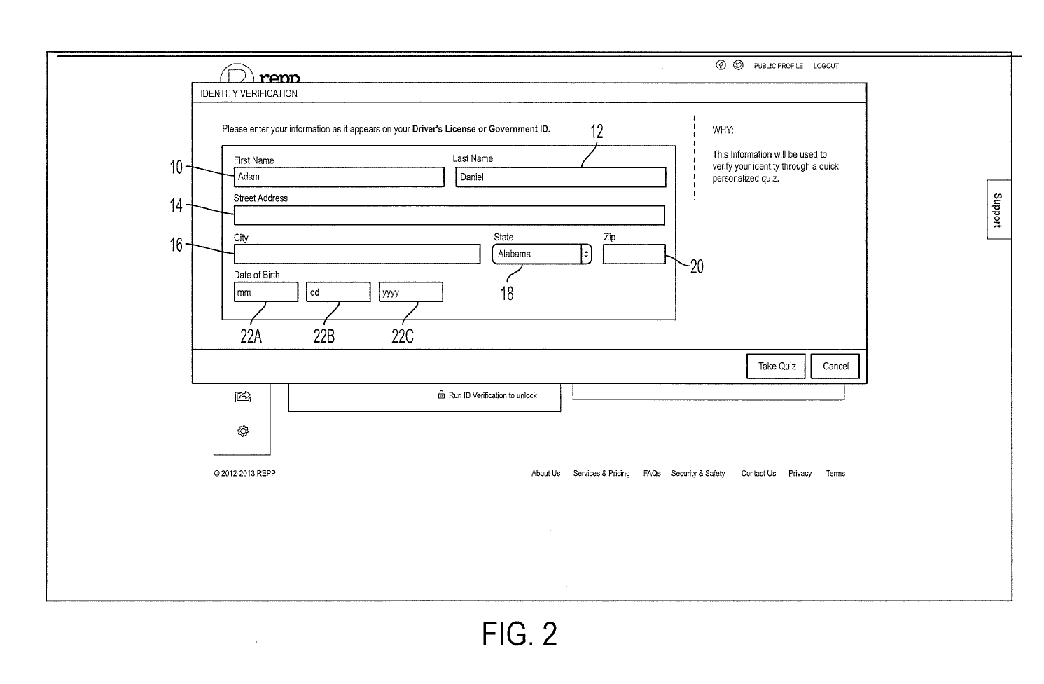

Turning now to FIG. 2, a process for a user creating a profile in accordance with an embodiment of the invention is described. The user can be an individual or an entity such as a business. The types of information gathered in the process may vary depending on whether the user is an individual or an entity or the type of entity. In the exemplary embodiment described below, the user is an individual. As part of the account creation process, identity information regarding the individual is gathered. FIG. 2 is a screen shot including fields for entering the user's first name in field 10, the user's last name in field 12, the user's street address in field 14, the user's city in field 16, the user's state in field 18, the user's zip code in field 20, and user's date of birth in field 22A, B, C. The types of information gathered may vary depending on the implementation. For example, for a business, information regarding registered agents, a business address, certifications and the like, may be gathered for verification.

Once the user's identity information is received, a verification process is initiated. The identity information input by the user may be shared with a third party service provider verification system. The verification system may check the user's identity information against their database. Any confirmation or results from the verification are then returned. The returned information is utilized to verify the user's identity. Other processes and technology may also be used to verify the user's identity. In the described embodiment, the returned information is mined to generate a quiz from the publicly available data returned by the verification process.

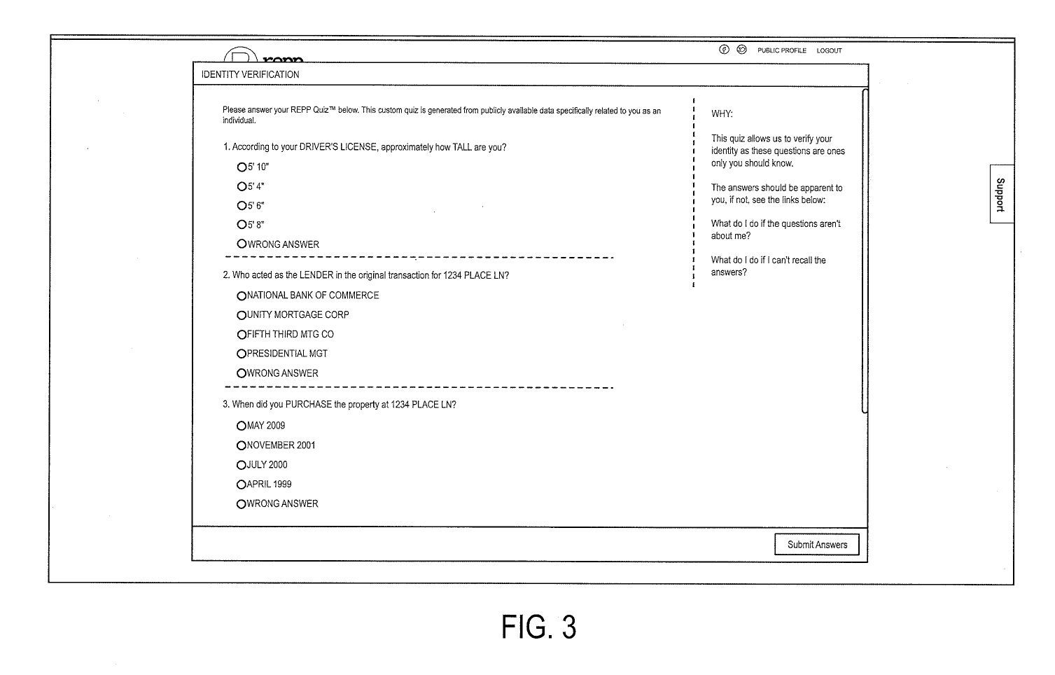

FIG. 3 illustrates an example of an authentication quiz. If the user can not answer each question correctly, the user is not allowed to proceed and the process may end. In this example, the verification system provides three knowledged based questions based on the identification information of the user. Other numbers and types of questions may also be used. These questions may be multiple choice questions which the user then can answer. As each question is answered, the answer may be passed along to the verification system which may verify the answer and return either a pass or fail for that question. Once the user answers all of the questions correctly, its confirmed that they are who they say they are and the process may continue.

Once the identity is verified, a background check may be run. The background check may automatically connect with a number of different databases, such as criminal courts, Department of Corrections, arrest logs, sexual offender registry, and the like. If the searches do not return any records based on the user's name, date of birth, address or information, it is reported that the user does not have any records that could be located. If the search does return some records, a match detection process, described below, may be initiated to grade the likeness that the record is for that individual. The match process attempts to reduce false positives. If the match algorithm returns a false positive, then that record is not shown to the user. If records are returned and they are not determined to be false positives, the records are provided to the user with an associated match score. The match score process is described in more detail below. The user may then be provided with the option to claim or disclaim the record. Additionally, the user may be provided the option to add context to the record. For example, they may explain why it is them, why it is not them, or provide general context regarding on incident is in the record.

The returned and verified information is then used to create to users profile. The ability to share the profile and to respond to requests is provided. Partner organizations may request access and an analysis of a users profile. A criteria process, described in more detail below, may then be initiated to score the user profile. Additionally, a user account page may be provided. From the user account page, the user may manage messages with other users. This may include managing profile requests, profile views, and system messages. The user can also see the status of current and past shared profiles. The users are provided the ability to create a custom profile. In a custom profile the user can select what elements are included in the profile, for example, the background check, social media contacts, etc. The user is given the option to control with who the custom profile is shared and how long it is shared. The users can embed or share the profile through the web, social media, etc. For example, the profile may be embedded in dating, Craigs List, Collaborate Consumption, and the like. The profile can be combined with social media to provide verified social media accounts.

Turning now to the match detection process, once the information is gathered from the user and a record retrieved from the service provider, it is determined if the service provider's record is actually that of the user. This process may be done automatically. For example, the user inputs data for John Smith, born on Dec. 1, 1960. A background check may be run using that data and the relevant information obtained from the service provider. The background check may return a DWI record. The likeliness that the record is the user John Smith or is another John Smith is determined.

In an exemplary embodiment, both the user and the service provider's records may include a name (first, middle, last, & suffix) and a date of birth (month, day, & year). Additional information or a subset of this information may also be used in other embodiments. The gathered information is input into the below fields and provided various weights depending on their alikeness.

First name

Middle name

Last name

Suffix

Date of birth—month

Date of birth—day

Date of birth—year

All of these fields have an associated score or weight. The score may be determined by comparing the user's first name to the name of the first name from the service provider's record. The user's date of birth may also be compared to the date of birth returned from the service provider's records. The more similar the names and dates, the higher the score may be. The scores for each field may be compiled and averaged to determine the match score. Next, the likeliness (very likely, likely, possibly, not likely) of the user being the person identified in the service provider's record is determined based on the match score.

An early match detection process may be used to determines if a piece of information, such as the names and birth dates, matches a previously determined value, and if it does, it sets the score of that piece of information to a predetermined value. These may categorized as cases. In an exemplary embodiment, there are three general cases.

One Empty Case (No information from one source)—If one of the sources of information (the user or service provider) does not provide a value for a field but the other source of information does provide a value for that field, that field's associated score may be set to a predetermined value, such as 50. Other predetermined values may be used depending on the implementation details.

Both Empty Cases—If both sources of information do not provide a value for a field that is not related to a date, the field's associated score may be set to a second predetermined value, such as 60. If the field is related to a date, the score may be set to 0 instead of 60. The score may be set to 60 because there is a higher likeliness that it is a match than not. Other predetermined values may be used depending on the implementation details.

Middle Case Initial Matching—If either the user or the service provider gives an initial for a middle name and the other party provides a full middle name with the first character of the middle name matching the initial, the middle name field's attached score is set to 75 because there is a higher likeliness that is it a match than not. Other predetermined values may be used depending on the implementation details.

If both the user and the service provider provide a value for a field and it does not fall into any of the above cases, the value undergoes further processing to determine a score. In an exemplary embodiment of the invention, names may go through a normalized word distance process and dates may go through a normalized date algorithm.

Below is a chart of the exemplary cases based on the early match detection process:

| | one empty | both empty | initial match |
|---|---|---|---|
| first name | 50 | 60 | |
| middle name | 50 | 60 | 75 |
| last name | 50 | 60 | |
| suffix | 50 | 60 | |
| dob - month | 50 | | |
| dob - day | 50 | | |
| dob - year | 50 | | |

The exemplary normalized word distance process takes in two words and returns a score on how alike the words are using principles from the Levenshtein distance algorithm. That score is then set as the associated score of the field for the word that went into the process.

In an example process, the Levenshtein distance between the two values is determined. This result is used as “distance” throughout the rest of the process. The maximum distance is also determined. The maximum distance may be the length in characters of the longest word. (1−(Distance/MaxDistance)*100) is then rounded to the nearest integer.

For example, the user supplied first name is “Albert.” The service provider's record first name is “Albaop.” The Levenshtein distance application is applied to these names:
1. Albert→Albaop (substitution of “e” for “a”)
2. Albert→Albaop (substitution of “r” for “o”)
3. Albert→Albaop (substitution of “t” for “p”)

Accordingly, the distance from Albert to Albaop is 3

Next, 1 minus the distance (3) is divided by max distance (6) multiplied by 100 and rounded to the nearest hundredth place.
1. Round (1−(3/6))
2. This gives 0.5
3. Multiply 0.5 by 100 and this gives 50

50 would then be set as the attached score of the first name field.

Turning now to the normalized date process, the birth dates from the user and the service provider's record are compared and a score is returned based on how alike the dates are. In some embodiments, each date may be given a margin of allowance of 3. That means the dates can be within +/−3 days, months, or years (respectively) of each other to account for typos and trans-positioned numbers before the dates are dismissed as not matching. Other margins of allowance may also be used depending on the implementation details. The returned score from this process is then set as the associated score for the field that the date which went into the process at the start of its execution.

In an exemplary process, the absolute difference between the two dates is determined. Next, (1−abs((diff/3 [the margin of allowance]))*100) is rounded to the nearest hundredth. If the result is less than 0, the result is replaced with 0 and that is returned as the result. Otherwise the result is the score for that date.

For example, the user supplied Date Of Birth is 21. The service provider record indicates a Date Of Birth is 26. First, the absolute value of the difference between the two numbers 26 and 21 is determined, 5 for the absolute difference. Then 1 minus the absolute difference (5) is divided by 3 and then rounded to the nearest hundredth place. In this example, that is −0.66. Multiply −0.66 by 100=−66. If the resulting number is less than 0, set the resulting number to 0. Since −66 is less than zero (0), 0 would be set as the attached score of the date of birth-month field.

Below is an example of the early match detection algorithm working:

| | User | Service Provider | |
|---|---|---|---|
| Field Name | Entry | Record | Attached Score Value |
| First Name | | Jane | 50 |
| Middle Name | J | Johnston | 75 |
| Last Name | Doe | Downs | Calculate Normalized |
| | | | Word Distance |
| Suffix | | | 60 |
| Date of Birth Month | March | | 50 |
| Date of Birth Day | | | 0 |
| Date of Birth Year | 1994 | 1980 | Calculate Normalized |
| | | | Date Distance |

To get the total score, the scores attached to each field are averaged, then round it to the nearest whole number. The total represents the likeliness of record being that of the user. After the total score has been determined, categorize as either “not likely, possibly, likely or very likely” is done based on the total score. The higher the score the more likely that the user is the person returned from the service provider's records. In an example, ranges are assigned to each category as shown in the table below. Other ranges may also be used.

| RANGE | MATCH POSSIBLILITY |
|---|---|
| 90-100 | Very Likely |
| 80-89 | Likely |
| 70-79 | Possibly |
| 0-69 | Not Likely |

At certain times, there is a need to automatically determine if a user's profile meets certain standards or specified criteria. The Criteria process is an automated process to analyze each profile and automatically label it based on the individual elements that make it up.

A user creates a profile, which includes running their information, including returned criminal records, business checks, and other verifications, through the match process to determine likeliness as well as providing the user the ability to claim/disclaim any records. Each profile is analyzed with the Criteria process to determine if certain thresholds are met.

The following criteria are provided for each User—a) Pass, b) Fail, c) Insufficient data.
a. Pass=No Y types of records in last X years
b. Fail=Y records in last X years.
c. Insufficient=Unsure if they have records or do not have enough information about the person.

The user is run through the match process in order to determine likeliness. The user's records and information that the match process utilized are analyzed. If the user has an offense on their public records and the offense date on the record is more than X years ago, a PASS is automatically returned as it is older than required X years. If the offense date is less than X years ago, it is checked to see if the user has any Y types of records. If there is not any Y record, a PASS is returned. If there is a Y record, a) the person's match score is greater than or equal to 80 or b) if the person claimed the offense. This provides a foundation for linking this record to the person as the higher the match score, the higher the possibility of the person being the one who actually committed the offense.

If the person claimed the Y offense and/or has a match score greater than or equal to 80, a FAIL is returned, as it is determined that it is their record. If the person did not claim the Y offense and or has a match score between 70 and 79, an INSUFFICIENT is returned.

With a match score between 70 and 79, there is uncertainty of the person's identity, so an INSUFFICIENT is returned since there is not extreme confidence that it is indeed them who committed the offense, but there is also at the same time possibility that they did commit the offense.

If the person's match score is less than 70 we return a PASS.

There may be uncertainty that it is them who committed the offense if their match score is below a 70. There is not have enough information about the person to come to any conclusions.

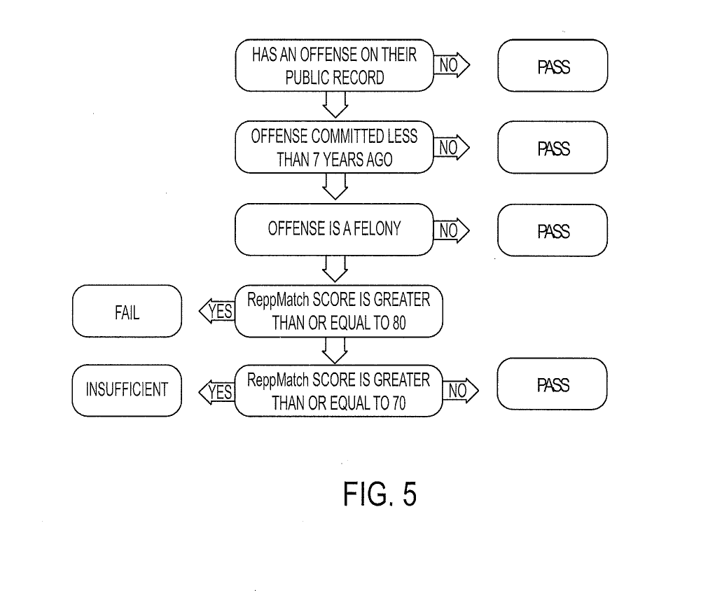

FIG. 5 Illustrates an exemplary process flow where the criteria is set to locate a felony within the prior seven years. Thus, variable Y is set to “felony” and variable X is set to seven years. In step 50, the information returned from the service provider is examined to determine if there an offense is indicated. If the record does not indicate an offense, the process may end at step 51 and indicate “pass.” If an offense is found, the flow may continue to step 52 where it is determined in the offense occurred within the prescribed time period, here seven years. If the offense did not occur in the last seven years, the flow may end at step 53 and indicate “pass.” If the offense falls within the prescribed time period, the flow continues at step 54 where it is determined if the offense is a felony. If the offense is not a felony, the flow may end at step 55 and return “pass.” If the criteria X and Y are both met, the match score is examined is step 56. If the match score is greater than or equal to 80, the process returns a “fail” and ends at step 57. If the match score is less than 80 the flow continues at step 58. In step 58, if the match score is greater than or equal to 70, the process returns an “insufficient” at step 59 and there is not enough information to make a determination. If the match score is less than 70, the process returns a “pass” at step 60.

The table below is an example of automatic process according to an embodiment of the invention.

| Person's | Match | Offense In | Years Since | Process |
|---|---|---|---|---|
| Name | Score | Records | Offense | Results |
| Brian | 82 | Yes | 3 | FAIL |
| Stewart | 61 | NO | n/a | PASS |
| Glenn | 70 | YES | 5 | INSUFFICIENT |
| Megan | 74 | YES | 12 | PASS |

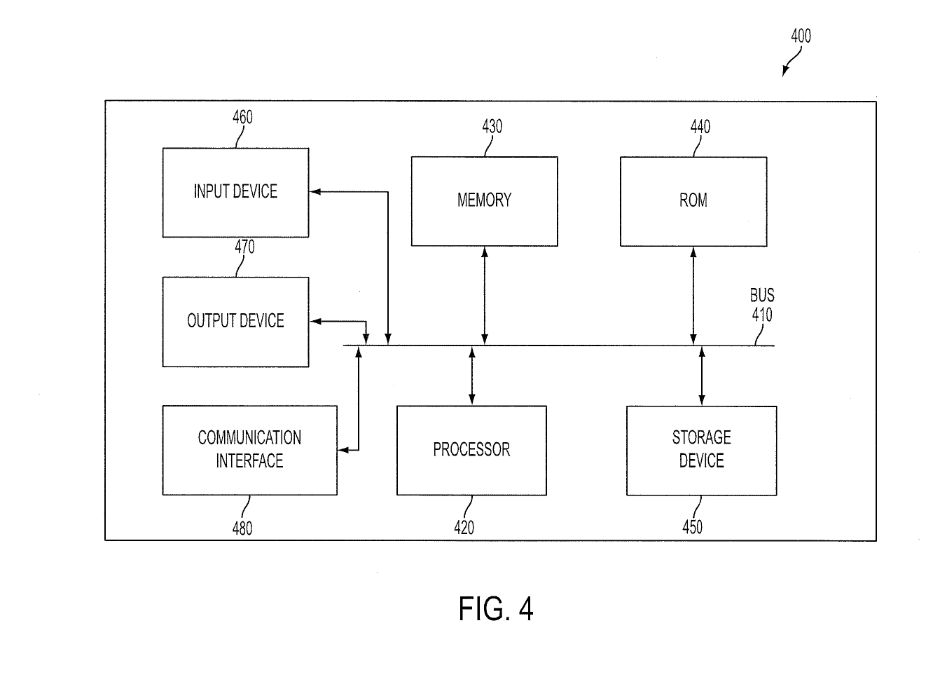

FIG. 4 depicts an exemplary architecture for implementing a computing device 400 in accordance with one or more embodiments, which may be used to implement any of the computing devices discussed herein, or any other computer system or computing device component thereof. It will be appreciated that other devices that can be used with the computing device 400, such as a client or a server, may be similarly configured. As illustrated in FIG. 4, computing device 400 may include a bus 410, a processor 420, a memory 430, a read only memory (ROM) 440, a storage device 450, an input device 460, an output device 470, and a communication interface 480.

Bus 410 may include one or more interconnects that permit communication among the components of computing device 400. Processor 420 may include any type of processor, microprocessor, or processing logic that may interpret and execute instructions (e.g., a field programmable gate array (FPGA)). Processor 420 may include a single device (e.g., a single core) and/or a group of devices (e.g., multi-core). Memory 430 may include a random access memory (RAM) or another type of dynamic storage device that may store information and instructions for execution by processor 420. Memory 430 may also be used to store temporary variables or other intermediate information during execution of instructions by processor 420.

ROM 440 may include a ROM device and/or another type of static storage device that may store static information and instructions for processor 420. Storage device 450 may include a magnetic disk and/or optical disk and its corresponding drive for storing information and/or instructions. Storage device 450 may include a single storage device or multiple storage devices, such as multiple storage devices operating in parallel. Moreover, storage device 450 may reside locally on the computing device 400 and/or may be remote with respect to a server and connected thereto via network and/or another type of connection, such as a dedicated link or channel.

Input device 460 may include any mechanism or combination of mechanisms that permit an operator to input information to computing device 400, such as a keyboard, a mouse, a touch sensitive display device, a microphone, a pen-based pointing device, and/or a biometric input device, such as a voice recognition device and/or a finger print scanning device. Output device 470 may include any mechanism or combination of mechanisms that outputs information to the operator, including a display, a printer, a speaker, etc.

Communication interface 480 may include any transceiver-like mechanism that enables computing device 400 to communicate with other devices and/or systems, such as a client, a server, a license manager, a vendor, etc. For example, communication interface 480 may include one or more interfaces, such as a first interface coupled to a network and/or a second interface coupled to a license manager. Alternatively, communication interface 480 may include other mechanisms (e.g., a wireless interface) for communicating via a network, such as a wireless network. In one implementation, communication interface 480 may include logic to send code to a destination device, such as a target device that can include general purpose hardware (e.g., a personal computer form factor), dedicated hardware (e.g., a digital signal processing (DSP) device adapted to execute a compiled version of a model or a part of a model), etc.

Computing device 400 may perform certain functions in response to processor 420 executing software instructions contained in a computer-readable medium, such as memory 430. In alternative embodiments, hardwired circuitry may be used in place of or in combination with software instructions to implement features consistent with principles of the disclosure. Thus, implementations consistent with principles of the disclosure are not limited to any specific combination of hardware circuitry and software.

Exemplary embodiments may be embodied in many different ways as a software component. For example, it may be a stand-alone software package, a combination of software packages, or it may be a software package incorporated as a “tool” in a larger software product. It may be downloadable from a network, for example, a website, as a stand-alone product or as an add-in package for installation in an existing software application. It may also be available as a client-server software application, or as a web-enabled software application. It may also be embodied as a software package installed on a hardware device.

Numerous specific details have been set forth to provide a thorough understanding of the embodiments. It will be understood, however, that the embodiments may be practiced without these specific details. In other instances, well-known operations, components and circuits have not been described in detail so as not to obscure the embodiments. It can be appreciated that the specific structural and functional details are representative and do not necessarily limit the scope of the embodiments.

It is worthy to note that any reference to “one embodiment” or “an embodiment” means that a particular feature, structure, or characteristic described in connection with the embodiment is included in at least one embodiment. The appearances of the phrase “in one embodiment” in the specification are not necessarily all referring to the same embodiment.

Although some embodiments may be illustrated and described as comprising exemplary functional components or modules performing various operations, it can be appreciated that such components or modules may be implemented by one or more hardware components, software components, and/or combination thereof. The functional components and/or modules may be implemented, for example, by logic (e.g., instructions, data, and/or code) to be executed by a logic device (e.g., processor). Such logic may be stored internally or externally to a logic device on one or more types of computer-readable storage media.

Some embodiments may comprise an article of manufacture. An article of manufacture may comprise a storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of storage media include hard drives, disk drives, solid state drives, and any other tangible storage media.

It also is to be appreciated that the described embodiments illustrate exemplary implementations, and that the functional components and/or modules may be implemented in various other ways which are consistent with the described embodiments. Furthermore, the operations performed by such components or modules may be combined and/or separated for a given implementation and may be performed by a greater number or fewer number of components or modules.

Some of the figures may include a flow diagram. Although such figures may include a particular logic flow, it can be appreciated that the logic flow merely provides an exemplary implementation of the general functionality. Further, the logic flow does not necessarily have to be executed in the order presented unless otherwise indicated. In addition, the logic flow may be implemented by a hardware element, a software element executed by a processor, or any combination thereof.

While various exemplary embodiments have been described above, it should be understood that they have been presented by way of example only, and not limitation. Thus, the breadth and scope of the present disclosure should not be limited by any of the above-described exemplary embodiments.

We claim:

1. A method, comprising:
receiving identity information from a user;
using the identity information to obtain a public record check from a remote database;
determining if the public record is for the user, including;
comparing the name and birth date material from the user and the name and birth date information from the public record check to obtain a score for each;
combining the scores to obtain a match score;
determining the public record check is for the user if the match score if above a predetermined threshold.

2. The method of claim 1, further comprising:
determining if the identity information from the user including at least a name and birth date information
determining if the public record check including at least name and birth date information;
assigning a predetermined score to the data filed if both the identity information form the user include name data, if one of the identity information includes the identity information, or if neither identity information includes the identity information.

3. The method of claim 2, wherein the identify information includes a name:
determining a Levenshtein distance between the names;
determining a maximum distance for the name;
determining the score based on the distance and the maximum distance.

4. The method of claim 2, wherein the identity information includes birth date information:
determining an absolute difference between the birth date information;
determining a margin of error;
determining the score based on the absolute difference and the margin of error.

5. The method of claim 1, further comprising:
receiving criteria regarding information from the public records check;
receiving second criteria regarding a time of the first criteria;
determining if the first criteria is present in the public records check;
determining if the first criteria occurs within the second criteria;
examining the match score; and
determining if the user passes, fails, or there is insufficient based on the first and second criteria and the match score.
